(19) United States
(12) Patent Application Publication
(10) Pub. No.: US 2026/0138927 A1
(43) Pub. Date: May 21, 2026

(54) FABRICATION OF DOPED TRANSPARENT POLYCRYSTALLINE CERAMIC MATERIALS

(71) Applicant: CORNING INCORPORATED, CORNING, NY (US)

(72) Inventors: David August Sniezek Loeber, Montour Falls, NY (US); Haitao Zhang, Ithaca, NY (US)

(21) Appl. No.: 19/120,449

(22) PCT Filed: Oct. 27, 2023
(86) PCT No.: PCT/US2023/036088

§ 371 Date: Apr. 11, 2025

Related U.S. Application Data
(60) Provisional application No. 63/421,253, filed on Nov. 1, 2022.

(51) Int. Cl. C04B 35/505; C04B 35/16; C04B 35/626; C04B 35/64

(52) U.S. Cl. CPC C04B 35/505; C04B 35/16; C04B 35/62645; C04B 35/62695; C04B 35/64; C04B 2235/3225; C04B 2235/3427; C04B 2235/5454; C04B 2235/6025; C04B 2235/656; C04B 2235/662; C04B 2235/666; C04B 2235/785; C04B 2235/85; C04B 2235/9653

(57) ABSTRACT

Solution synthesis of rare-earth-doped nanoparticles, followed by flash sintering of the nanoparticles, can produce rare-earth-doped transparent polycrystalline ceramics with beneficial optical and/or mechanical properties, such as low optical losses, high optical coherence, high refractive-index controllability, and/or high mechanical strength. In one example application, high-quality erbium-doped yttria for quantum memory devices can be fabricated.

### CROSS-REFERENCE TO RELATED APPLICATIONS

This application claims the benefit of priority under 35 U.S.C. § 119 of U.S. Provisional Application No. 63/421,253 filed Nov. 1, 2022, the content of which is incorporated herein by reference in its entirety.

### TECHNICAL FIELD

This disclosure pertains to rare-earth-doped transparent ceramics and methods of making them.

### BACKGROUND

Quantum memory has become an area of intense research for applications in both quantum communications and quantum computing. In quantum communications, a key research area is the creation of quantum repeater systems, and quantum memory constitutes an important element of such systems. Another application of quantum memory, relevant to both quantum communication and quantum computation, are single photon sources, which utilize quantum memory to store a photon state from a probabilistic source for later release at a deterministic trigger.

Erbium-doped materials are promising candidate materials for quantum memory. Erbium memory operates with photons in the 1.5 μm telecommunication band, and research has shown that the memory-state lifetime (T2) can be as long as on a milliseconds scale, aligning with the requirements for quantum repeater systems. While in the past the best performance for quantum-state lifetime has generally been achieved with crystalline materials, it has more recently been shown that the lifetime in polycrystalline ceramic materials can be comparable to that in single-crystal devices. For example, erbium-doped ceramic materials that maintain long quantum-state lifetimes while, beneficially, also being optically transparent can be made, e.g., using a hot isostatic pressing (HIP) process. While producing high-quality material, the HIP process is slow and requires relatively expensive equipment. Furthermore, the long processing times and high temperatures in HIP enable wide-scale diffusion of elements within the materials, which places limitations on the ability to make ceramic materials with a composition gradient through the material. Composition gradients can be desirable, for instance, for the construction of waveguides, which are useful structures for quantum systems.

### BRIEF DESCRIPTION OF THE DRAWINGS

Described herein are methods of forming rare-earth-doped transparent polycrystalline ceramic materials. Various embodiments are described with reference to the accompanying drawings, in which:

FIGS. 1A and 1B are flowcharts of methods of forming transparent polycrystalline ceramic materials from rare-earth-doped nanoparticles by flash sintering.

FIGS. 2A and 2B are flowcharts of methods of synthesizing rare-earth-doped nanoparticles.

### DETAILED DESCRIPTION

Described herein are processes for producing high-quality, transparent rare-earth-doped polycrystalline ceramics from nanoparticles, using flash sintering. Flash sintering falls in the general category of field-assisted sintering techniques (FAST), which use electrical or electromagnetic fields to enhance the rate of sintering, that is, the rate of coalescing and densifying particulate material into a porous or solid mass. In flash sintering, the simultaneous application of heat and a direct-current (DC), alternating-current (AC), or pulsed electrical field across the material causes, at certain combinations of temperature and electrical field strength, a sudden increase in the conductivity of the material and a resulting electrical current flow through the material, which is accompanied by a sudden and significant increase in the sintering rate. Flash sintering can densify ceramic materials in extremely short times, such as from a few seconds to a few minutes, as compared with other (including other field-assisted) sintering techniques, which may take hours. Additionally, flash sintering can generally occur at much lower temperature (e.g., hundreds of degrees Celsius lower) than other sintering techniques, in some instance even accomplishing sintering at near room temperature. Beneficially, this drastic reduction of process time and process temperature can entail significant reductions in energy consumption and economic cost as compared with, e.g., HIP and other conventional processes.

In addition to providing an economic advantage, flash sintering also facilitates producing microstructures and beneficial material properties that are not, or not to the same extent, achievable by other sintering methods. The shortened process times and reduced temperatures suppress crystal grain growth and pore encapsulation in the polycrystalline material, which increases transparency as well as mechanical strength. The improvement in transparency, in turn, can expand the range of ceramic materials suitable for quantum-optical or other optical applications, e.g., by allowing for unsymmetric polycrystalline ceramics. Further, the short process times and lower temperatures employed in flash sintering also suppress dopant diffusion and agglomeration at the grain boundary, enabling a more uniform dopant distribution, which benefits optical coherence properties and, in quantum-optical applications, quantum-state lifetime. Greater dopant uniformity also achieves better control and tunability of the refractive index profile in the material, facilitating, for instance, making layered ceramic waveguide structures with high index contrast between core and cladding. Flash sintering can also produce ceramics with out-of-equilibrium compositions, i.e., dopant concentrations above the dopant solubility in the polycrystalline matrix material, which further increases index tunability.

The flash-sintering-based fabrication processes described herein are applicable to a wide range of transparent polycrystalline ceramics, generally including a polycrystalline matrix (or lattice) of a metal compound, such as a metal oxide or salt. Contemplated herein are, in particular (although not exclusively), compounds of transition metals (i.e., elements in the d-block of the periodic table), such as yttrium (Y), zirconium (Zr), or hafnium (Hf), and compounds of main group metals such as aluminum (Al), calcium (Ca), or magnesium (Mg). The transparent polycrystalline ceramics may include one or more rare-earth dopants distributed throughout the polycrystalline metal-compound matrix. Rare-earth dopants include the “inner transition metals” (i.e., elements in the f-block of the periodic table), which include lanthanides (e.g., lanthanum (La) and erbium (Er)) and actinides, as well as yttrium and scandium (Sc).

Rare-earth element dopants in a crystal lattice can feature a shaped spectral structure corresponding to a superposition of states that can transition between energy states, along with a long optical coherence, which render them suitable for storing single photons in quantum memory devices (e.g., as described in U.S. Pat. No. 10,304,536, which is incorporated herein by reference). Rare-earth dopants can also be used to tune the refractive index of a material. In some applications, the polycrystalline material is co-doped with a first rare-earth dopant for photon storage and a second dopant for refractive-index tuning. An example material suitable for quantum-memory applications is erbium-doped yttria (Er—Y2O3), optionally co-doped with lanthanum for use, e.g., as a waveguide core in a quantum memory system. Other materials that may be used in quantum-optical or other applications include, for example, rare-earth doped cerium oxide (CeO2), yttrium orthovanadate (YVO4), yttrium aluminum garnet (Y3Al5O12), yttrium silicate (Y2SiO5), yttrium titanate (Y2Ti2O7), calcium tungsten oxide (CaWO4), strontium tungsten oxide (SrWO4), lanthanum trifluoride (LaF3), and yttrium lithium fluoride (LiYF4). Of course, as will be understood by those of ordinary skill in the art, the rare-earth-doped transparent polycrystalline ceramics described herein are not limited in their applications to quantum memory. Other potential areas of application include, without limitation, gain hosts of solid state lasers, scintillators, ceramics phosphors, and infrared windows.

In various embodiments, polycrystalline ceramics are formed from rare-earth-doped nanoparticles having a narrow distribution of diameters with an average diameter of less than 200 nm, less than 100 nm, or less than 50 nm (e.g., about 40 nm) and a standard deviation of no more than 20 nm. Such nanoparticles can be synthesized from compounds (e.g., salts or coordination complexes) of the underlying (e.g., transition) metal of the polycrystalline matrix material and rare-earth metal by heating the metal compounds in water and mixing them with an organic precursor (e.g., urea). In some embodiments, the metal compounds, water, and organic precursor are heated together in a mixture; in other embodiments, the metal compounds and water are pre-heated and thereafter mixed with the organic precursor to induce formation of rare-earth-doped nanoparticles. The latter, beneficially, tends to achieve smaller nanoparticle diameters. With small-diameter nanoparticles as the starting material and the very limited grain growth sustained in the flash sintering process, transparent rare-earth-doped polycrystalline ceramic materials with grain sizes within the sub-micrometer range, e.g., average grain sizes of less than 1 μm, less than 500 nm, less than 100 nm, or even less than 50 nm can be achieved.

Further, by doping the nanoparticles themselves, rather than relying on dopant diffusion in a conventional sintering process, uniform rare-earth dispersion at the atomic level can be achieved, and a trade-off between the uniformity of the rare-earth distribution throughout the polycrystalline matrix and the grain size is avoided. A “uniform distribution” of the rare-earth dopant is herein understood as a distribution in which at least 50% of the rare-earth dopant is located inside the grains of the polycrystalline matrix, away from the grain boundaries. In various embodiments, as a result of the short process time and concomitant suppressed diffusion of dopant towards the grain boundaries, significantly greater degrees of uniformity can be achieved, e.g., with 80% or more, or even 95% or more, of rare-earth dopant located inside the grains and away from the grain boundaries.

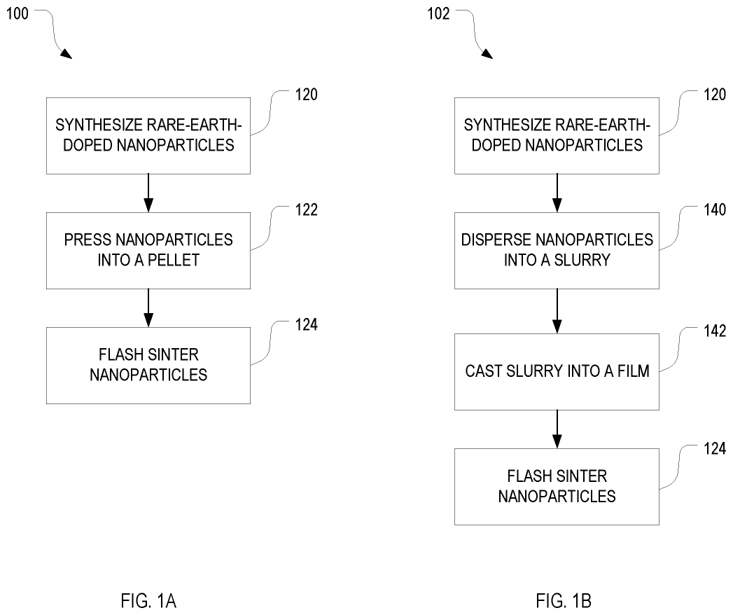

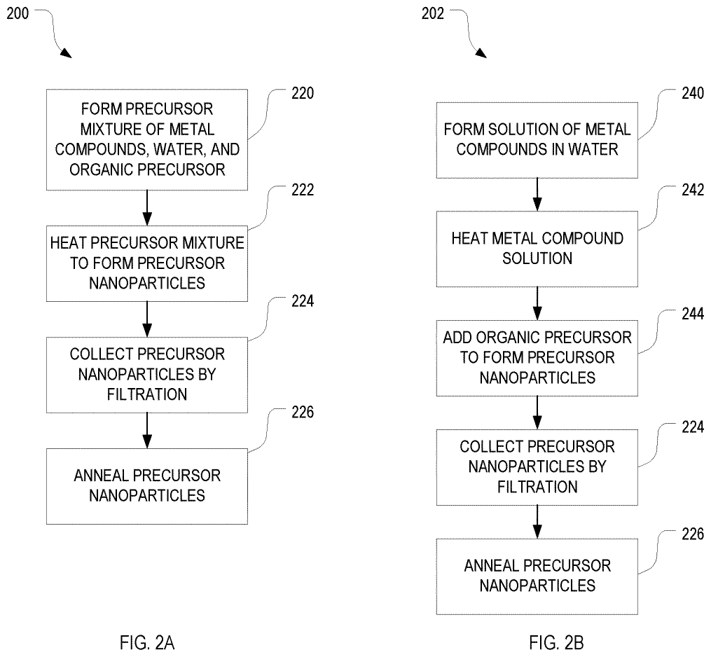

Turning now to the drawings, FIGS. 1A and 1B are flowcharts of methods 100, 102 of forming transparent polycrystalline ceramic materials from rare-earth-doped nanoparticles by flash sintering. With reference to FIG. 1A, the method 100 begins with the synthesis of rare-earth-doped nanoparticles (120), e.g., using either of the methods 200, 202 described below with reference to FIGS. 2A and 2B. The nanoparticles may have a narrow size distribution with an average diameter of less than 200 nm, less than 150 nm, less than 100 nm, less than 50 nm, or less than 40 nm, for example. In one example, Er-doped yttria nanoparticles about 40 nm in size are made. The nanoparticles may be pressed into a pellet (122). For instance, a nanoparticle sample may be pressed uniaxially, e.g., in a ¾ inch steel die at a force of about 8 K pounds, and then further pressed iso-statically, e.g., at about 25 Kpsi using an iso-pressing sheath.

The nanoparticle pellet is then flash sintered (124). For this purpose, the pellet may be placed in a heating surface and connected between two electrodes (e.g., platinum electrodes) that apply a DC, AC, or pulsed voltage across the pellet to create an electrical field in the material, e.g., having a field strength in the range from 5 V/cm to 1000 V/cm. In some embodiments, the electrical field is held constant, e.g., at 500 V/cm, while the furnace is heated up, e.g., at a constant ramp rate between 1 and 100° C./min, until an electrical current through the sample is observed, indicating a sudden increase in the conductivity of the material and the onset of flash sintering. In other embodiments, the temperature is fixed, and the electrical field is instead ramped up, e.g., at a constant rate, until a current flow and flash sintering start. Upon the onset of flash sintering, the power supply that generates the electrical field is switched from voltage control to current control. For example, the current may be set to a range between 10 mA and 10 A. A higher sintering current generally results in faster sintering. The current may be maintained, and sintering allowed to continue, for a period of time. In general, sintering is complete within a time period between a few seconds and several minutes (e.g., less than ten minutes, less than one minute, less than thirty seconds, or less than 10 seconds), depending on the sintering current and material. Accordingly, after such time, the furnace and power supply may be shut off. Optionally, in some embodiments, flash sintering is followed by conventional sintering (e.g., HIP), for a shorter period and/or at a lower temperature than would be used without a preceding flash sintering step.

To illustrate the performance and effect of flash sintering, in one example, a pellet of 40-nm-sized Er—Y2O3 nanoparticles was placed in an electrical field of 500 V/cm and heated in a furnace at a ramp rate of 10° C./min. At the beginning, no electrical current across the sample was detected. At 1218° C., a strong electrical current appeared, indicating the start of flash sintering. Flash sintering was allowed to continue at a current of 30 mA for sixty seconds, before electrical field and furnace were turned off. For comparison, a second pellet of the same type was placed in the furnace to undergo the same thermal process, but without an applied electrical field. After completion of this process, the density of both samples was compared. The density of the pellet that was flash sintered exceeded that of the pellet sintered through heat alone by 26%.

With reference now to FIG. 1B, the method 102 likewise begins with the synthesis of rare-earth-doped nanoparticles (120), e.g., using either of the methods 200, 202 described below with reference to FIGS. 2A and 2B. The nanoparticles may then be dispersed into a slurry (140), e.g., by adding a suitable solvent (e.g., ethanol or de-ionized water) to a nanoparticle sample and milling the mixture with a suitable milling media (e.g., yttria stabilized zirconia grinding media) for a duration on the order of tens of hours. The slurry may be separated from the milling media by filtration, and mixed with one or more binders and/or plasticizers. Optionally, the slurry may be rolled to remove air. The slurry may then be cast into a film (142) using a suitable casting process, such as tape casting or spin coating. After casting, the film may be dried, e.g., in air under a cover for about a day, followed by oven-drying for about half an hour. In this manner, thin nanoparticle films with thicknesses in the range from a few to tens of micrometers (e.g., less than 100 μm) can be fabricated. In some embodiments, multiple nanoparticle films of different compositions can be disposed on top of one another to create a layered structure. Finally, the nanoparticle film or layered stack of films is flash sintered (124), in the same manner as described above with reference to FIG. 1B, to create the rare-earth-doped transparent polycrystalline ceramic (optionally followed by conventional sintering).

FIGS. 2A and 2B are flowcharts of methods 200, 202 of synthesizing rare-earth-doped nanoparticles. With reference to FIG. 2A, the method 200 involves mixing compounds, such as salts or complexes, of a first metal (e.g., transition metal) that will be part of the polycrystalline matrix and of a second metal (or multiple second metals) that will constitute the rare-earth dopant(s) with water (such as de-ionized water) and an organic precursor (such as urea, ammonium hydroxide, or the like) to form a precursor mixture (220). The precursor mixture is then heated (222), e.g., to a temperature between 70° C. and 100° C. for a period of between half an hour and several hours, to induce the formation of precursor rare-earth-doped nanoparticles in solution. Thermal decomposition of the organic precursor during the heating process may produce OH⁻ and CO₃²⁻ ions, which react with the transition and rare-earth metals of the metal compounds to form the precursor rare-earth nanoparticles. The precursor nanoparticles may be filtered and collected (224), and then annealed (226) in air or at an elevated temperature (e.g., between 500° C. and 900 ° C.) to convert the precursor nanoparticles into the final rare-earth doped nanoparticles, which have a crystalline structure. For example, the precursor mixture may include yttrium chloride complexes, YCl₃·6H₂O, and erbium chloride complexes, ErCl₃·6H₂O, and may be heated to form of Y₁₋ₓErₓ(OH)CO₃·H₂O precursor nanoparticles, which are converted to (Y₁₋ₓErₓ)₂O₃ nanoparticles.

FIG. 2B illustrates a modified nanoparticle synthesis process 202 that begins with mixing metal compounds (such as salts or complexes) of a first metal (e.g., transition metal) that will be part of the polycrystalline matrix and of a second metal (or multiple second metals) that will constitute the rare-earth dopant(s) in water (such as de-ionized water) to form a metal compound solution (240), and then preheating that solution (242), e.g., to a temperature between 70° C. and 100° C., before adding the organic precursor (e.g., urea) (244). The temperature of the organic precursor may be less than, the same as, or greater than the temperature of the metal compound solution at the time of mixing. The addition of the organic precursor to the solution induces the formation of precursor rare-earth-doped nanoparticles in solution. As compared with the precursor nanoparticles generated by the process 200 of FIG. 2A, the preheating of the metal compound solution can result in smaller nanoparticle diameters. Upon formation of the precursor nanoparticles, the process 202 proceeds, like process 200, with filtering and collecting (224) and then annealing (226) the precursor nanoparticles to obtain the final rare-earth-doped nanoparticles. In either process 200, 202, the concentration of the metal compounds in the precursor mixture or solution determines the size of the formed nanoparticles. Lower concentrations generally result in smaller nanoparticle diameters. Further, the ratio of the first (transition) metal and second, rare-earth metal compounds in the solution determines the dopant level within the polycrystalline ceramic. The amount of rare-earth metal compounds (e.g., measured in grams) may be about two or three orders of magnitude lower than that of the metal compounds for the matrix, resulting in dopant levels of less than 1%, but higher dopant levels, including dopant levels greater than 10%, are also possible.

The described processes for synthesizing rare-earth-doped nanoparticles and flash sintering them into ceramics can produce high-quality, transparent rare-earth-doped polycrystalline ceramics, generally at lower energetic and economic cost than conventional sintering processes (such as, e.g., HIP). Further, in various embodiments, the produced ceramics benefit in various ways from smaller grain sizes, reduced porosity, and/or more uniform dopant distributions as compared with transparent rare-earth-doped polycrystalline materials produced by such other sintering processes.

The short process times and reduced process temperatures employed in flash sintering can contribute in two ways to low optical losses (e.g., losses of less than 0.5 dB/cm), corresponding to higher transparency, of the resulting ceramics. For one thing, flash sintering reduces the encapsulation of pores into grains. Pores inside grains cannot be removed by conventional sintering, and they are detrimental to the transparency of sintered ceramics. By reducing, and potentially largely eliminating, such residue pores, flash sintering can produce ceramics with higher transparency.

Another effect benefiting transparency is that flash sintering minimizes crystal grain growth, resulting in ceramics with smaller grain size. Sufficiently small grain size bears the potential of making transparent ceramics with unsymmetric crystal structures. Previously, transparent ceramics have been limited to symmetric materials (mostly with cubic crystal structures), which have an isotropic refractive index. By contrast, in unsymmetric polycrystalline ceramics (e.g., having monoclinic or triclinic crystal structures), the randomly oriented grains can scatter light, thereby reducing transparency. Such scattering can be reduced, and transparency accordingly be improved, by reducing the grain size to a small fraction (e.g., less than one tenth) of the wavelength at which the rear-rear earth dopant is active and the device made from the ceramic material operates. Thus, if unsymmetric ceramics are fully densified at a crystal size of less than 100 nm, as is possible by flash sintering of small (e.g., 30-nm-diameter) nanoparticles, they can accommodate operating wavelengths as low as about, or greater than, one micrometer, which includes the 1.5 μm telecommunication band that is of great practical interest. Expanding candidate materials to ceramics with unsymmetric crystals facilitates leveraging advantageous properties of such materials. One example of an unsymmetric material with monoclinic crystal structure that has been shown to be a good matrix material for rare-earth dopants in optical quantum studies is yttrium orthosilicate (Y2SiO5).

Flash sintering, due its short process time and low temperature, also suppresses or minimizes dopants diffusion, which can improve optical coherence properties. Transparent ceramics for optical quantum memory applications are usually doped by rare-earth elements, which serve as the active species in the optical process. Good performance, corresponding to long optical coherence times, is achieved if the rare-earth dopants reside inside the crystalline grains and maintain good dispersion. By synthesizing rear-earth-doped nanoparticles via a solution method as described herein with reference to FIGS. 2A and 2B, uniform rare-earth dispersion at the atomic level can be achieved within the nanoparticles. Conventional sintering, however, would induce dopants diffusion towards the grain boundaries, which is an energetically favorable process. The resulting agglomeration of rear-earth dopants in the grain boundary or in a surface layer of grains would be detrimental to the optical coherence properties of the material. Flash sintering the rare-earth-doped nanoparticles, on the other hand, can suppress rear-earth dopants diffusion, and thus optimize optical coherence properties of the rare-earth-doped ceramics. Note that alternative methods that create rare-earth-doped ceramics by sintering a mixture of matrix material (e.g., yttria) and rare-earth oxide particles rely on certain diffusion processes to incorporate rare-earth ions into the matrix material. Accordingly, it is the combination of synthesizing rare-earth-doped nanoparticles and flash-sintering those particles into transparent ceramics, in accordance with the methods described herein, that achieves rare-earth-doped ceramics with good optical coherence.

The suppression of dopant dispersion incidental to flash sintering is also beneficial for tuning the refractive index and controlling the index profile of the transparent polycrystalline ceramic material. The refractive index of rare-earth doped ceramics can be tuned, e.g., for the purpose of fabricating optical waveguides, by adding one or more second dopants, such as, e.g., lanthanum (La), lutetium (Lu), scandium (Sc), and/or gadolinium (Gd). Like the primary dopant that serves the purpose of photon storage or some other optical process, these index modifiers are incorporated into the nanoparticles via solution synthesis (e.g., as described with reference to FIGS. 2A and 2B) to achieve uniform dispersion. With a conventional sintering process, the diffusion of index modifier to the grain boundary would tend to produce a non-uniform index profile and reduce the efficiency of the index change. Flash sintering, via the suppression of dopants diffusion, can produce a more uniform index profile and maximize index tunability.

Suppressed dopants diffusion is also important for waveguide structures made by sintering multiple layers of nanoparticle thin films, as may be prepared by tape casting or spin coating. In one example, such a layered waveguide structure may include a waveguide core layer of lanthanum-and erbium-doped yttria (La—Er—Y2O3), sandwiched between an under cladding and top cladding of un-doped Y203. With a conventional sintering process, the diffusion of lanthanum from the core layer to the cladding layers could change the index profile and reduce the index difference between core and cladding. Flash sintering, as a result of the drastically limited diffusion, can achieve steeper compositional gradients, and thus provide better controllability of the index profile, than conventional sintering processes.

The flash sintering process also provides the capability of producing doped ceramics with out-of-equilibrium compositions, that is, compositions in which the dopant concentration in the matrix material exceeds the dopant solubility in the matrix material. For example, it is possible to make La-doped Y2O3 transparent ceramics with a lanthanum concentration higher than the solubility of La in Y2O3, which is about 10%, to further increase index tunability.

Beyond improving optical properties such as transparency, optical coherence, and index-tunability, flash sintering can also improve the mechanical properties of the fabricated ceramics due to smaller crystal grain sizes. This effect is especially important for thin films with thicknesses on the order of a few or tens of micrometers. With HIP or other conventional sintering processes, Y2O3/La—Er—Y2O3/Y2O3 nanoparticle thin films can be sintered into transparent tapes with grain sizes of about 1-5 micrometers, even if starting from nanoparticle sizes as small as 30 nm. Such tapes are fragile and difficult to process. Flash sintering allows making transparent ceramics with grain sizes close to those of the starting nanoparticles, e.g., grain sizes below 100 nm. Reducing grain size to the nanometer scale is an effective method to improve tape strength.

The possibility of fabricating nanometer grain-size polycrystalline ceramics also provides an opportunity to study crystal size effects on the optical coherence properties of the rare-earth dopants. Such data are useful to guide the development of thin-film-based optical micro devices, which are normally at the nanometer scale.

While the invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method of forming a rare-earth-doped transparent polycrystalline ceramic material, the method comprising:
synthesizing rare-earth-doped nanoparticles having an average diameter of less than 200 nm;
creating the rare-earth-doped transparent polycrystalline ceramic material by flash sintering a sample of the rare-earth-doped nanoparticles for a duration not exceeding ten minutes, using an electrical current through the sample that is created by heating the sample in the presence of an electrical field.

2. The method of claim 1, wherein the electrical current is created by heating the sample in a furnace and ramping up a temperature of the furnace until the electrical current starts to flow through the sample, and wherein the furnace and the electrical field are turned off at conclusion of the duration not exceeding ten minutes.

3. The method of claim 1, wherein the sample is flash sintered for a duration not exceeding one minute.

4. (canceled)

5. The method of claim 1, wherein a temperature of the sample during the flash sintering does not exceed 1300° C.

6. The method of claim 1, wherein the rare-earth-doped transparent polycrystalline ceramic material has a sub-micrometer average grain size.

7. The method of claim 1, wherein the rare-earth-doped nanoparticles have an average diameter of less than 100 nm.

8. (canceled)

9. (canceled)

10. The method of claim 1, wherein synthesizing the rare-earth-doped nanoparticles comprises:
heating a precursor mixture of a first metal compound, a rare-earth metal compound, water, and an organic precursor to induce formation of precursor rare-earth-doped nanoparticles in solution;
collecting the precursor rare-earth-doped nanoparticles from the solution by filtration; and
annealing the precursor rare-earth-doped nanoparticles to obtain the rare-earth-doped nanoparticles.

11. The method of claim 1, wherein synthesizing the rare-earth-doped nanoparticles comprises:
pre-heating a mixture of a first metal compound, a rare-earth metal compound, and water to form a heated metal compound solution;
mixing the heated metal compound solution with an organic precursor to form precursor rare-earth-doped nanoparticles in solution;
collecting the precursor rare-earth-doped nanoparticles from the solution by filtration; and
annealing the precursor rare-earth-doped nanoparticles to obtain the rare-earth-doped nanoparticles.

12. The method of claim 11, wherein the first metal compound comprises a transition metal salt or a transition metal complex, and wherein the rare-earth metal compound comprises a rare-earth metal salt or a rare-earth metal complex.

13. The method of claim 1, wherein the nanoparticles are erbium-doped yttria nanoparticles.

14. The method of claim 1, wherein the rare-earth-doped nanoparticles comprise first and second rare-earth dopants.

15. (canceled)

16. The method of claim 1, wherein the rare-earth doped transparent polycrystalline ceramic material comprises rare-earth dopant distributed throughout a polycrystalline metal-compound matrix.

17. The method of claim 16, wherein at least 80% of the rare-earth dopant are located inside grains of the polycrystalline metal-compound matrix away from grain boundaries.

18. (canceled)

19. The method of claim 1, further comprising pressing the sample of the rare-earth-doped nanoparticles into a pellet prior to flash sintering.

20. The method of claim 1, further comprising dispersing the sample of the rare-earth-doped nanoparticles into a slurry and casting the slurry into a film prior to flash sintering.

21. A transparent rare-earth-doped polycrystalline ceramic material comprising:
a polycrystalline metal-compound matrix having a grain size of less than 1 μm; and
a rare-earth dopant distributed throughout the polycrystalline metal-compound matrix, wherein at least 80% of the rare-earth dopant are located inside grains of the polycrystalline metal-compound matrix away from grain boundaries.

22. The transparent rare-earth-doped polycrystalline ceramic material of claim 21, wherein the metal-compound matrix comprises yttria and wherein: a) the dopant comprises erbium; or b) herein the dopant comprises erbium and one or more of lanthanum, scandium, lutetium, or gadolinium.

23. (canceled)

24. The transparent rare-earth-doped polycrystalline ceramic material of claim 21, wherein the metal-compound matrix comprises one of cerium oxide (CeO2), yttrium orthovanadate (YVO4), yttrium aluminum garnet (Y3Al5O12), yttrium silicate (Y2SiO5), yttrium titanate (Y2Ti2O7), calcium tungsten oxide (CaWO4), strontium tungsten oxide (SrWO4), lanthanum trifluoride (LaF3), or yttrium lithium fluoride (LiYF4).

25. The transparent rare-earth-doped polycrystalline ceramic material of claim 21, wherein: (i) the metal-compound matrix has an unsymmetric crystal structure; or (b) wherein the metal-compound matrix has an unsymmetric crystal structure: and comprises yttrium orthosilicate (Y2SiO5).

26. (canceled)

27. The transparent rare-earth-doped polycrystalline ceramic material, wherein a concentration of the rare-earth dopant is higher than the solubility of the rare-earth dopant in the metal-compound matrix.

28. A method of making a layered ceramic waveguide structure, the method comprising:
synthesizing first metal-compound nanoparticles having an average diameter of less than 200 nm;
synthesizing second, rare-earth-doped metal compound nanoparticles having an average diameter of less than 200 nm;
tape-casting an undercladding layer of the first metal compound nanoparticles;
tape-casting, on top of the undercladding layer, a waveguide core layer of the second, rare-earth-doped metal compound nanoparticles;
tape-casting, on top of the waveguide core layer, a cladding layer of the first metal compound nanoparticles; and
flash sintering the undercladding layer, waveguide core layer, and cladding layer to create a polycrystalline metal compound matrix having a grain size of less than 500 nm, wherein the waveguide core layer comprises rare-earth dopant distributed throughout the polycrystalline metal compound matrix.

29. The method of claim 28, wherein the first metal compound nanoparticles comprise yttria nanoparticles and the second metal compound nanoparticles comprise yttria nanoparticles doepd with erbium and one or more of lanthanum, scandium, lutetium, or gadolinium.
